(19) United States
(12) Patent Application Publication
(10) Pub. No.: US 2003/0196529 A1
(43) Pub. Date: Oct. 23, 2003

(54) Press for blanking metal plates

(75) Inventor: Wilfried Abt, Rechberghausen (DE)

Correspondence Address: CROWELL & MORING LLP, INTELLECTUAL PROPERTY GROUP, P.O. BOX 14300, WASHINGTON, DC, 20044-4300, US

(73) Assignee: Schuler Pressen GmbH & Co.

(21) Appl. No.: 10/418,051

(22) Filed: Apr. 18, 2003

(30) Foreign Application Priority Data
Apr. 18, 2002 (DE) 102 17173.4

(51) Int. Cl. B26D 1/00

(52) U.S. Cl. 83/13; 83/684

(57) ABSTRACT

A press for blanking metal plates, particularly stator segments of a generator or electric motor, has a blanking tool and a stacking device for stacking the blanked-out parts. The stacking device is arranged outside the blanking tool.

### BACKGROUND OF THE INVENTION

This application claims the priority of Germany, filed Apr. 18, 2002, the disclosure of which is (are) expressly incorporated by reference herein.

The present invention relates to a press for blanking metal plates, particularly stator segments of a generator or electric motor, having a blanking tool and a stacking device for stacking the blanked-out workpieces.

When manufacturing stators of a generator or electric motor, frequently only stator segments are blanked out of a plate metal strip in order to minimize the occurring blanking waste. When stator segments are blanked out, narrower plates can therefore also be processed. The use of narrower plates permits a manufacturing of the stator plates which is more accurate to size because narrower plates have lower rolling tolerances. The individual stator plate layers are stacked upon one another in the tool until the desired stator thickness has been achieved.

When manufacturing stators constructed of stator segments, before the depositing of another stator segment, the bottom die has to be further rotated by a certain angle of rotation until all segments of one layer are placed on a 360° circumference. When manufacturing stators composed of stator segments, stacking devices have been used which are integrated in the tool. However, the disadvantage of tools with an integrated stacking device are the corresponding newly occurring investment costs for the stacking device when a new tool is required.

### SUMMARY OF THE INVENTION

An object of the present invention is to improve a press of the aforementioned type such that, in the future, the investment costs for the stacking device can be advantageously eliminated when a new blanking tool is required.

The present invention achieves this object by producing a press for blanking metal plates, particularly stator segments of a generator or electric motor, having a blanking tool and a stacking device for stacking the blanked-out workpieces, with the stacking device being arranged outside the blanking tool. By using a stacking device arranged outside the blanking tool, this stacking device can be demounted from the old tool when a new tool is used and can be mounted on the new tool. In this manner, the investment costs for a stacking device will be saved when a new tool is used.

Consequently, the tool according to the present invention will be smaller and less expensive. As a result of the arrangement of the stacking device outside the blanking tool, the stacking device will no longer be as severely stressed by press shocks as previously, whereby maintenance work can be saved. The stacking station is therefore always the same even when different blanked metal parts are manufactured.

The stacking device may also be rotatable so that also the segment-type construction of round parts, such as stators of a generator or an electric motor, can take place. When manufacturing stator plates constructed in segments, before another stator segment is deposited, the stacking device is further rotated by a certain angle, until a stator plate layer composed of stator segments is deposited over a circumference of 360°.

In order to be able to feed the blanked-out workpieces to the stacking device, it is advantageous to provide a fetching or feeding device which feeds the blanked-out workpieces coming from the tool to the stacking device.

When the height of the stack of blanked parts continues to grow, it is advantageous for being able to stack additional blanked parts on the already stacked blanked parts to provide a device for compensating the increasing height of the already stacked blanked parts. This compensation can be implemented, for example, by a lowering device of the entire stacking device or by the fact that the height of the fetching device can be varied.

The stacking device becomes very flexible if it has pallets for receiving the blanked parts to be stacked. It is expedient to use several pallets for the stacking device which permits a continuous manufacturing operation. As soon as a pallet is loaded with a defined height of stacked blanked parts, this pallet can be replaced by an empty pallet.

For an effortless stacking which is protected against tipping over, the stacking device may have at least one holding arbor for a fitting-on of the blanked parts to be stacked.

In order to also avoid a tipping-over of stator segments to be stacked, the blanked-out stator segments of an upper layer are stacked offset with respect to the stator segments of a lower layer.

The blanked parts may have passage openings through which the at least one holding arbor of the stacking device is fitted. In addition, however, these passage openings also permit a bundling of blanked parts. During the bundling, the blanked parts of an upper layer, after the blanking but still during the pressing operation, are pressed upon the blanked parts of the lower layer. Thereby the material of the blanked parts of the upper layer flows into the passage opening of the blanked parts of the lower layer, whereby an anchoring of the mutually stacked layers is achieved.

In order to also avoid a tipping-over of the mutually stacked blanked parts, the blanked parts may have a recess on their one end and a protrusion on their other end. Therefore, when several blanked parts are joined, for example, during the joining of stator segments, the protrusion of one blanked part can engage in the recess of the other blanked part.

Furthermore, the invention involves a method of stacking blanked-out stator segments with the following steps:

(a) blanking of a stator segment,

(b) feeding and depositing the blanked-out stator segment on the stacking device,

(c) rotating the stacking device by a defined angle of rotation,

(d) repeating steps (a) to (c) until the complete circumference of a layer has been deposited on the stacking device;

(e) repeating steps (a) to (d) until the defined stator thickness has been reached.

### BRIEF DESCRIPTION OF THE DRAWINGS

Other objects, advantages and novel features of the present invention will become apparent from the following detailed description of the invention when considered in conjunction with the accompanying drawings.

FIG. 1 is a longitudinal sectional view of a press and a stacking device according to the present invention; and

FIG. 2 is a top view of the press and the stacking device of FIG. 1.

### DETAILED DESCRIPTION OF THE DRAWINGS

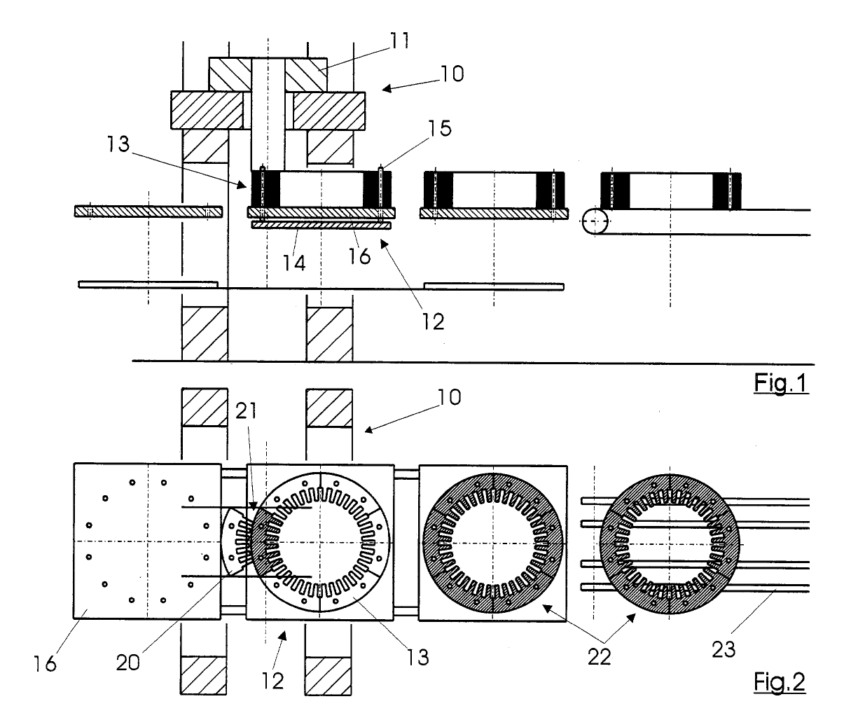

FIG. 1 shows a press 10 having an upper die 11. A stacking device 12 receives blanked-out parts 13 from the press 10. In the stacking device 12, the blanked parts 13 are stacked on one another up to a desired stacking height. The stacking device 12 has a rotatable platform 14 so that round parts, such as stators of a generator or of an electric motor, can be produced. The platform 14 is provided with holding arbors 15 onto which the blanked parts 13 can be fitted. An exchangeable pallet 16 is arranged on the platform 14, and receives the blanked parts 13. In order to be able to feed the blanked parts 13 coming from the press 10 to the stacking device 12, a known fetching or feeding device (not shown in detail) to feed the blanked-out parts 13 to the stacking device 12.

The fetching device may be configured, for example, as a magnet or a hook or in another manner known to a person skilled in the art. In addition, the stacking device 12 has a device for compensating the increasing height of the mutually stacked blanked parts 13, this devices also not being shown here in detail. The height compensation can, for example, take place in that the height of the fetching device can be varied or in that the platform 14 together with the pallet 16 can be lowered.

FIG. 2 illustrates the press 10 and the stacking device 12. Below the press 10, an empty pallet 16 is guided to the stacking device 12 in order to receive blanked parts 13. In the illustrated embodiment, the stator 22 of a generator or of an electric motor is produced. In the illustrated production step, a stator segment 20 is just being inserted into a gap 21 formed by already deposited blanked parts 13. As soon as the pallet 16 has received a sufficient number of blanked parts in the defined stacking height, the pallet 16 is further moved to the right. Finally, a finished workpiece 22 is transported to a conveyer belt 23 for further processing or use.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Press for blanking metal plates, including stator segments of a generator or electric motor, comprising a blanking tool and a stacking device for stacking the blanked-out parts, wherein
the stacking device is arranged outside the blanking tool.

2. Press according to claim 1, wherein
the stacking device is arranged to be rotatable.

3. Press according to claim 1, wherein
a fetching device is provided to guide the blanked-out parts to the stacking device.

4. Press according to claim 3, wherein
the stacking device is arranged to be rotatable.

5. Press according to claim 1, wherein
a device is provided for compensating increasing height of the mutually stacked blanked parts.

6. Press according to claim 5, wherein
the stacking device is arranged to be rotatable.

7. Press according to claim 6, wherein
a fetching device is provided to guide the blanked-out parts to the stacking device.

8. Press according to claim 1, wherein
the stacking device has pallets configured to receive the blanked parts to be stacked.

9. Press according to claim 8, wherein
the stacking device is arranged to be rotatable.

10. Press according to claim 9, wherein
a fetching device is provided to guide the blanked-out parts to the stacking device.

11. Press according to claim 10, wherein
a device is provided for compensating increasing height of the mutually stacked blanked parts.

12. Press according to claim 1, wherein
the stacking device is configured with at least one holding arbor.

13. Press according to claim 12, wherein
the stacking device is arranged to be rotatable.

14. Press according to claim 13, wherein
the stacking device has pallets configured to receive the blanked parts to be stacked.

15. Press according to claim 14, wherein
a fetching device is provided to guide the blanked-out parts to the stacking device.

16. Press according to claim 1, wherein
the stacking device stacks the blanked-out stator segments of an upper layer offset with respect to the stator segments of a lower layer.

17. Press according to claim 1, wherein
the blanked parts have passage openings.

18. Press according to claim 1, wherein
blanking tool is operable to produce the blanked parts with a recess on one end thereof and a protrusion on another end thereof.

19. Method of stacking blanked-out stator segments comprising:
(a) blanking of a stator segment;
(b) feeding and depositing the blanked-out stator segment on the stacking device;
(c) rotating the stacking device by a defined angle of rotation;
(d) repeating steps (a) to (c) until the complete circumference of a layer has been deposited on the stacking device; and
(e) repeating steps (a) to (d) until the defined stator thickness has been reached.
